(19) United States
(12) Patent Application Publication
(10) Pub. No.: US 2004/0223284 A1
(43) Pub. Date: Nov. 11, 2004

(54) Electrostatic attracting method, electrostatic attracting apparatus, and bonding apparatus

(75) Inventors: Munenori Iwami, Yokohama-shi (JP); Noboru Kuriyama, Yokohama-shi (JP); Koji Takeishi, Yokohama-shi (JP); Ikuo Hayafuji, Yokohama-shi (JP); Hirokazu Masuda, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/725,983

(22) Filed: Dec. 2, 2003

(30) Foreign Application Priority Data
Dec. 4, 2002 (JP) 2002-352710
Jun. 20, 2003 (JP) 2003-176608

(51) Int. Cl. H02H 1/00

(52) U.S. Cl. 361/234

(57) ABSTRACT

There is disclosed an electrostatic attracting method in which a direct-current voltage is applied to an electrode disposed at a table formed of a dielectric material to attract/hold a substrate onto a holding surface of the table with an electrostatic force produced thereby, the method comprising a first step of applying a voltage having a predetermined polarity to the electrode to charge the holding surface with an electric charge having a polarity different from that applied to the electrode, a second step of holding the substrate in contact with the holding surface to prevent electric charges charged on the holding surface from disappearing, and a third step of applying a voltage having a polarity different from that applied in the first step to the electrode in a state in which the substrate contacts the holding surface to produce an electric charge having the same polarity as that charged at the holding surface in the first step on the holding surface of the table, and attracting/holding the substrate with the electric charge together with the electric charge charged on the holding surface in the first step.

### CROSS-REFERENCE TO RELATED APPLICATIONS

This application is based upon and claims the benefit of priority from the prior Japanese Patent Applications No. 2002-352710, filed Dec. 4, 2002; and No. 2003-176608, filed Jun. 20, 2003, the entire contents of both of which are incorporated herein by reference.

### BACKGROUND OF THE INVENTION

1. Field of the Invention

The present invention relates to an electrostatic attracting method of attracting/holding a substrate onto a table by an electrostatic force, an electrostatic attracting apparatus, and a bonding apparatus in which the electrostatic attracting apparatus is used to bond two substrates to each other.

2. Description of the Related Art

In a manufacturing process of a flat display panel represented by a liquid crystal display panel, a bonding operation is carried out in which two substrates are disposed opposite to each other at a predetermined interval, and a liquid crystal as a fluid is sealed between the substrates to bond the substrates together by a sealing agent.

In the bonding operation, either of two substrates is coated with the sealing agent in a frame shape, and a predetermined amount of the liquid crystal is dropped/supplied to the substrate or to a portion of the other substrate corresponding to a portion in a frame of the sealing agent.

Next, the two substrates are held by upper and lower holding tables, and are disposed opposite to each other at a predetermined interval in a vertical direction. In this state, the substrates are positioned in X, Y, and θ directions which are horizontal directions of these substrates, and one substrate is driven downwards to bond the substrates to each other.

The substrates are bonded to each other in a reduced-pressure chamber. After bonding the substrates, a gas is introduced into the chamber to raise the pressure. Then, one pair of substrates bonded to each other can be pressurized with a load sufficiently larger than a bonding load by a difference pressure between a pressure between the pair of bonded substrates and a pressure in the chamber.

When two substrates are bonded to each other in the chamber, the substrates are attracted to the pair of tables in vacuum. Then, the pressure in the chamber is reduced, and accordingly a holding force of the substrates is lost. Therefore, the substrate held by the upper holding table drops, or the substrates sometimes shift on the tables, when two substrates are brought in contact with each other and positioned.

To solve the problem, an electrode is disposed at least on the upper holding table in one pair of holding tables, and a direct-current voltage is applied to the electrode. Accordingly, since an electrostatic force is generated in a holding surface of the holding table, the substrate is attracted/held by the electrostatic force. Such technique is disclosed in Jpn. Pat. Appln. KOKAI Publication No. 2000-66163.

When the substrate is attracted/held onto the holding table by the electrostatic force, the holding force depends on a magnitude of the direct-current voltage applied to the electrode. As described above, when one pair of substrates of a liquid crystal display panel are bonded to each other, a high voltage exceeding ten kilovolts is sometimes required to be applied as the direct-current voltage to the electrode in order to increase the electrostatic force so that the substrates held on the holding tables are prevented from shifting.

However, when the high voltage exceeding ten kilovolts is applied to the electrode, dielectric breakdown occurs by discharge on the holding tables and in the chamber, the holding tables are sometimes damaged, or an electric charge is insufficiently accumulated into the electrode and a large electrostatic force cannot sometimes be produced on the holding tables.

An object of the present invention is to provide an electrostatic attracting method in which an electrostatic force produced on a table can be increased without applying a high voltage to an electrode, and a substrate can securely be held; an electrostatic attracting apparatus, and a bonding apparatus.

### BRIEF SUMMARY OF THE INVENTION

According to the present invention, there is provided an electrostatic attracting method in which a direct-current voltage is applied to an electrode disposed at a table formed of a dielectric material to attract/hold a substrate onto a holding surface of the table with an electrostatic force produced thereby, the method comprising:

a first step of applying a voltage having a predetermined polarity to the electrode to charge the holding surface with an electric charge having a polarity different from that applied to the electrode;

a second step of holding the substrate on the holding surface; and

a third step of applying a voltage having a polarity different from that applied in the first step to the electrode in a state in which the substrate is held on the holding surface to produce an electric charge having the same polarity as that charged on the holding surface in the first step at the holding surface of the table, and attracting/holding the substrate with the electric charge together with the electric charge charged on the holding surface in the first step.

According to the present invention, there is provided an electrostatic attracting apparatus which attracts/holds a substrate, comprising:

a table formed by a dielectric material and including a holding surface which holds the substrate by an electrostatic force;

an electrode disposed at the table;

a direct-current power supply which applies a direct-current voltage onto the electrode; and

switch means for switching a polarity of a direct-current voltage applied to the electrode by the direct-current power supply,

wherein after applying the direct-current voltage having a predetermined polarity to the electrode, the substrate is held on the holding surface, the switch means is operated to apply a direct-current voltage having a different polarity to the electrode.

According to the present invention, there is provided a bonding apparatus in which a fluid is disposed between two substrates to bond these substrates to each other by a sealing agent, the apparatus comprising:

a chamber in which a pressure of an inner space can be reduced;

a pair of tables which are disposed opposite to each other in the chamber and which include holding surfaces to hold the substrates on the surfaces disposed opposite to each other and at least one of which is formed of a dielectric material;

an electrode disposed at the table formed of the dielectric material;

a direct-current power supply which applies a direct-current voltage to the electrode and produces an electrostatic force to hold the substrate on the holding surface of the table;

switch means for switching a polarity of the direct-current voltage applied to the electrode by the direct-current power supply; and

driving means for driving the pair of tables with respect to each other in vertical and horizontal directions and positioning the substrates held on the holding surfaces of the pair of tables in the horizontal direction to bond the substrates to each other,

wherein after applying the direct-current voltage having a predetermined polarity to the electrode, the substrate is held on the holding surface, the switch means is operated to apply a direct-current voltage having a different polarity to the electrode.

According to the present invention, after charging the holding surface of the table with the electric charge having the predetermined polarity, the electric charge is prevented from disappearing, and the electric charge having the same polarity is further supplied. Therefore, an electric charge amount supplied onto the holding surface increases, and the electrostatic force produced on the holding surface accordingly increases.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic constitution diagram of a bonding apparatus according to one embodiment of the present invention;

FIG. 2 is a control circuit diagram for applying a direct-current voltage having a predetermined polarity to an electrode;

FIG. 3 is an explanatory view of a first step of charging a holding surface of an upper holding table with an electric charge having the predetermined polarity;

FIG. 4 is an explanatory view of a second step of holding the substrate on the holding surface charged with the electric charge having the predetermined polarity; and

FIG. 5 is an explanatory view of a third step of switching a polarity of the direct-current voltage applied to the electrode to a reverse polarity.

### DETAILED DESCRIPTION OF THE INVENTION

One embodiment of the present invention will hereinafter be described with reference to the drawings.

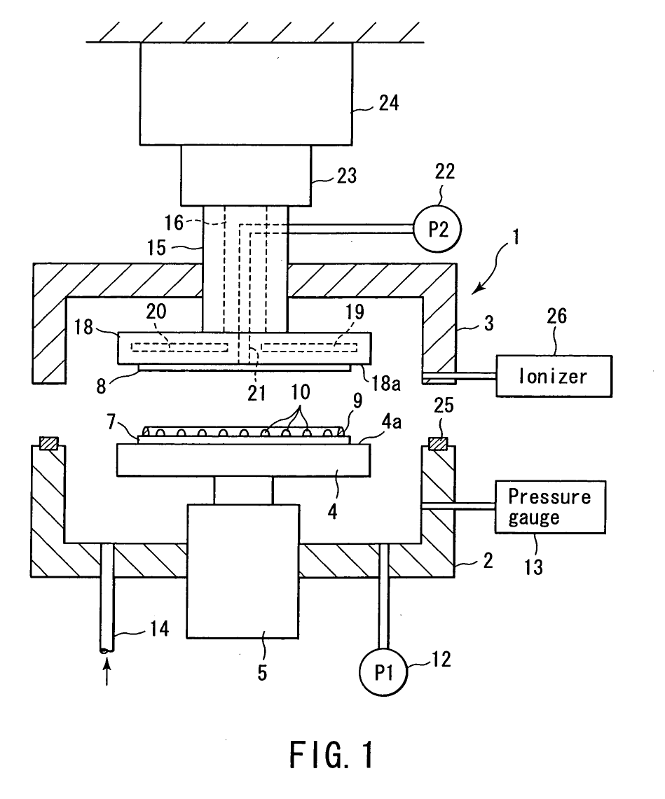

FIG. 1 shows a bonding apparatus according to one embodiment of the present invention. An electrostatic attracting apparatus of the present invention is used in this bonding apparatus. That is, the bonding apparatus includes a chamber 1. The chamber 1 is airtightly connectably divided into a lower chamber 2 and an upper chamber 3.

A lower holding table 4 is disposed in the lower chamber 2 in such a manner that the table can be driven by a first driving source 5 in X, Y, and θ directions, that is, in the horizontal direction. For first and second substrates 7 and 8 formed of glass or resin to constitute liquid crystal display panels, the first substrate 7 is supplied/laid on a holding surface 4a which is an upper surface of the lower holding table 4.

An elastic sheet (not shown), for example, having a predetermined friction resistance is disposed on the holding surface 4a. The first substrate 7 is held so as to be immobile in the horizontal direction on the holding surface 4a by contact resistance with the elastic sheet. The upper surface of the first substrate 7 held by the holding surface 4a is coated with a sealing agent 9 in a rectangular frame shape, and droplet-shaped liquid crystals 10, which are fluids, are dropped/supplied in a matrix form in the frame.

The lower chamber 2 is connected to a first vacuum pump 12 which is pressure reducing means. A pressure of an inner space of the chamber 1 constituted of the chambers is reduced by the first vacuum pump 12 in a state in which the upper chamber 3 is connected to the lower chamber 2 in an airtight manner as described later. The reduced pressure in the chamber 1 is measured with a pressure gauge 13 connected to the lower chamber 2. The lower chamber 2 is further connected to a gas supply tube 14 for supplying a gas into the chamber 1 after bonding two substrates 7, 8 to each other. An open/close control valve (not shown) is disposed in the gas supply tube 14.

An attached member 15 is inserted through an upper wall of the upper chamber 3 in the airtight manner. A movable shaft 16 is movably inserted through the attached member 15, an upper holding table 18 is disposed on a projected lower end of the movable shaft 16 in the upper chamber 3.

The upper holding table 18 is formed in a plate shape having a predetermined thickness by dielectric materials such as polyimide or ceramic, and a first electrode 19 and a second electrode 20 forming one pair are buried in a middle portion in a thickness direction. A direct-current voltage is applied to these electrodes 19, 20 as described later, and the second substrate 8 is attracted/held onto a holding surface 18a which is a lower surface of the upper holding table 18 with an electrostatic force produced by the voltage.

It is to be noted that one end of a suction hole 21 is opened/formed in a holding surface 18a of the upper holding table 18. A second vacuum pump 22 and a pressurized gas supply source (not shown) are switchably connected to the other end of the suction hole 21. When the second vacuum pump 22 operates, a suction force can be produced in the suction hole 21. Therefore, the second substrate 8 can be attracted/held on the holding surface 18a of the upper holding table 18 by a vacuum attracting force.

Moreover, when the pump is changed to the pressurized gas supply source, and a gas is spouted from the suction hole 21 constituting an open hole, the attracted/held substrate 8 can be detached from the holding surface 18a by the pressure of the spouted gas.

A second driving source 23, capable of driving the movable shaft 16 in a vertical direction corresponding to a Z direction and vertically driving only the upper holding table 18 separately from the upper chamber 3, is disposed on an upper end of the attached member 15 projecting from a top surface of the upper chamber 3. The second driving source 23 is driven together with the upper chamber 3 by a third driving source 24 in the Z direction. When the upper chamber 3 is driven in a descending direction by the third driving source 24, a lower end surface of the chamber abuts on an upper end surface of the lower chamber 2 on which a sealing material 25 is disposed in the airtight manner. Accordingly, the inside of the chamber 1 is closed in the airtight manner.

The upper chamber 3 is connected to an ionizer 26 which is charged particle supply means. The ionizer 26 is capable of spraying the gas containing electrically charged particles toward the holding surface 18a of the upper holding table 18.

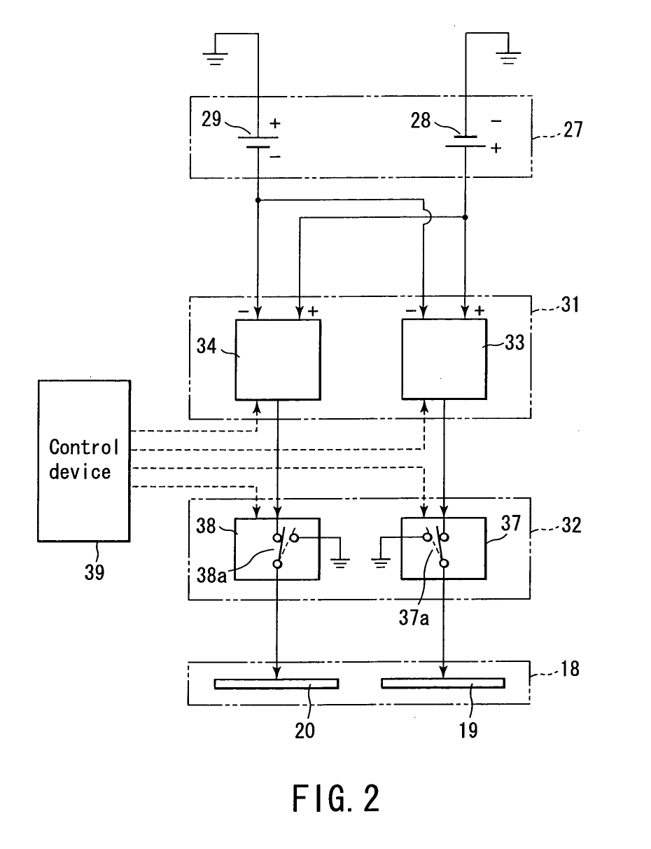

As shown in FIG. 2, the first electrode 19 and the second electrode 20 are connected to a first direct-current power supply 28 and a second direct-current power supply 29 disposed in a power supply section 27 via a switch device 31 and an earth device 32. The switch device 31 includes a first polarity changing section 33 and a second polarity changing section 34.

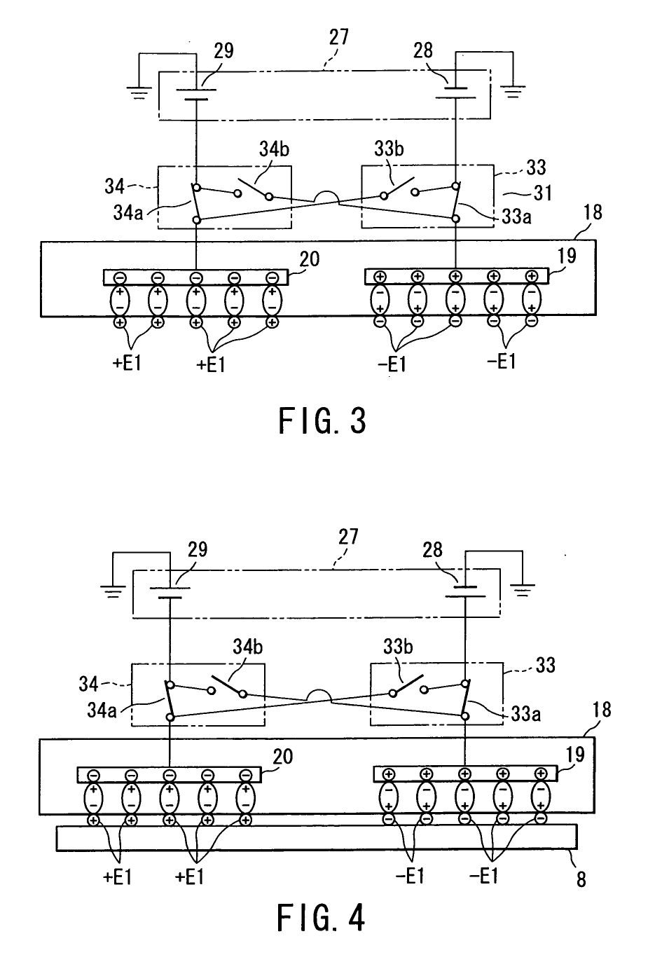

As shown in FIG. 3, the polarity changing sections 33, 34 include first and second changeover switches 33a, 33b, 34a, 34b. When these changeover switches are operated, the polarity of the direct-current voltage applied to the first and second electrodes 19, 20 is reversed.

The earth device 32 includes a first earth changing section 37 connected to the first polarity changing section 33, and a second earth changing section 38 connected to the second polarity changing section 34. The first earth changing section 37 is connected to the first electrode 19 disposed on the upper holding table 18 via a changeover switch 37a, and the second earth changing section 38 is connected to the second electrode 20 via a changeover switch 38a.

The respective changeover switches of the first and second polarity changing sections 33, 34 and first and second earth changing sections 37, 38 can be operated by a control device 39 which is control means. That is, when the first and second switches 33a, 33b, 34a, 34b of the first and second polarity changing sections 33, 34 are in a state shown in FIG. 3, an anode voltage of the first direct-current power supply 28 is applied to the first electrode 19 via the first polarity changing section 33 and the first earth changing section 37. Similarly, a cathode voltage of the second direct-current power supply 29 is applied to the second electrode 20 via the second polarity changing section 34 and the second earth changing section 38.

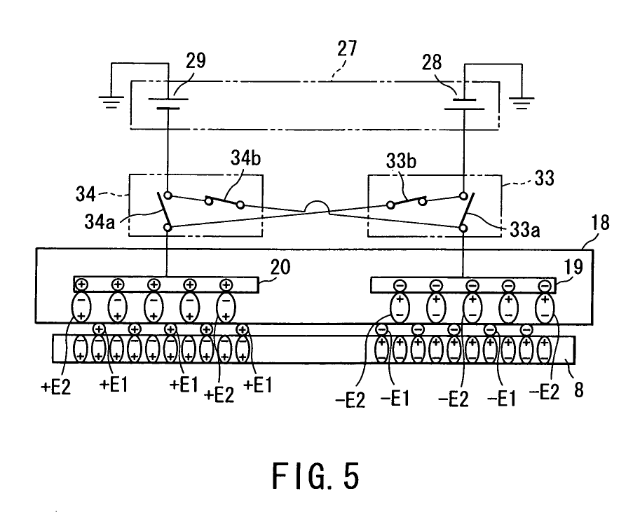

When the first and second switches 33a, 33b, 34a, 34b of the first polarity changing section 33 and second polarity changing section 34 are operated by the control device 39 as shown in FIG. 5, the cathode voltage of the second direct-current power supply 29 is applied to the first electrode 19, and the anode voltage of the first direct-current power supply 28 is applied to the second electrode 20.

The changeover switches 37a and 38a of the first and second earth changing sections 37 and 38 of the earth device 32 are changed/operated in a state shown by a chain line from a state shown by a solid line in FIG. 2 by the control device 39, the first and second electrodes 19 and 20 are earthed. Accordingly, the charges stored in these electrodes 19, 20 are released.

Next, a procedure for bonding the first and second substrates 7 and 8 together by the bonding apparatus constituted as described above will be described with reference to FIGS. 3 to 5.

First, in a first step, the first substrate 7 which is coated with the sealing agent 9 and on which the liquid crystal 10 is dropped is supplied/laid on the lower holding table 4 in a state in which the lower chamber 2 is disposed apart from the upper chamber 3. Then, as shown in FIG. 3, the first changeover switches 33a, 34a of the first and second polarity changing sections 33, 34 of the switch device 31 are turned on, and the second changeover switches 33b, 34b are maintained in an off state. Accordingly, the anode voltage of the first direct-current power supply 28 is applied to the first electrode 19 disposed at the upper holding table 18, and the cathode voltage of the second direct-current power supply 29 is applied to the second electrode 20.

The upper holding table 18 at which the first and second electrodes 19 and 20 are provided is disposed in the atmosphere. Therefore, when the voltages having predetermined polarities are applied to the first and second electrodes 19, 20, the charged particles are generated by a polarization phenomenon or a momentary ionization phenomenon of gas components existing in the atmosphere. The holding surface 18a of the upper holding table 18 is charged with the charged particles, or a moisture in the atmosphere is polarized and charged.

Concretely, as shown in FIG. 3, a portion of the holding surface 18a of the upper holding table 18 corresponding to the first electrode 19 is charged with a cathode charge −E₁ having a polarity reverse to that of the direct-current voltage applied to the first electrode 19. A portion of the holding surface 18a corresponding to the second electrode 20 is charged with an anode charge +E₁ having a polarity reverse to that of the direct-current voltage applied to the second electrode 20. At this time, as shown in FIG. 3, cathode and anode are polarized in a portion between the first and second electrodes 19 and 20 and the holding surface 18a of the upper holding table 18.

It is to be noted that to charge the upper holding table 18, the lower and upper chambers 2 and 3 are closed, and the inside of the chamber 1 is preferably brought in a pressure atmosphere indicating 10 Pa or more including a pressure which is not less than an atmospheric pressure. With a pressure of 10 Pa or more, it is possible to generate the charged particles by the polarization phenomenon or the momentary ionization phenomenon of the gas components existing in the pressure atmosphere and to satisfactorily charge the holding surface 18a with the electric charges. It is to be noted that it is possible to charge the holding surface 18a with the electric charge even with a pressure of 10 Pa or less in the chamber 1. When the pressure is not less than the atmospheric pressure, the ionization phenomenon occurs by the application of the voltage, and it is therefore possible to charge the holding surface.

When the pressure inside the chamber 1 is set to 10 Pa or more, the pressure is varied in a pressure range of 10 Pa or more. Then, the pressure atmosphere in which discharge easily occurs can surely be produced, and the charged particles can efficiently be generated by the discharge.

The upper chamber 3 is connected to the ionizer 26. Therefore, even when the gas containing the charged particles is spouted toward the upper holding table 18 from the ionizer 26, the holding surface 18a can efficiently electrically be charged.

Moreover, even when the inside of the chamber 1 is brought into the atmosphere containing steam or oxygen, a satisfactory polarization or ionization phenomenon can be obtained. When the inside of the chamber 1 has the atmosphere containing steam or oxygen, instead of the ionizer 26, a steam generation device or an oxygen supply device may be used to positively supply steam or oxygen to the chamber 1.

When the upper holding table 18 is electrically charged as described above, next in a second step, the second substrate 8 is held onto the holding surface 18a of the upper holding table 18 by vacuum attraction as shown in FIG. 4. Accordingly, the electric charges on the holding surface 18a are prevented from being lost.

That is, when discharge occurs between the holding surface 18a and a conductor around the chamber 1 or the like, the electric charges of the holding surface 18a are lost due to the discharge. However, when the substrate 8 constituted of an insulating material is held on the holding surface 18a, no discharge occurs between the holding surface 18a and the conductor around the chamber 1 or the like, and the electric charges can be prevented from being lost.

Even when the second substrate 8 is held on the holding surface 18a, the polarities of the electric charges −E₁, +E₁ on the holding surface 18a are different from those of the electric charges positioned on a holding surface 18a side among the electric charges polarized between the holding surface 18a and the respective electrodes 19, 20, and these electric charges different from one another in polarity attract one another. Therefore, the suction force by the electric charge is hardly generated in the holding surface 18a. Therefore, a holding force of the second substrate 8 by the electric charges on the holding surface 18a is remarkably small. Therefore, the second substrate 8 is held on the holding surface 18a by a vacuum suction force by the second vacuum pump 22.

It is to be noted that the first step of electrically charging the upper holding table 18 is carried out under the pressure atmosphere of 10 Pa or more while the chamber 1 is hermetically closed. In this case, when the second substrate 8 is supplied into the chamber 1 beforehand, the substrate can be held on the upper holding table 18 without opening the chamber 1 in a second step. In this case, supply holding means for holding the second substrate 8 supplied beforehand into the chamber 1 in the chamber 1 and for supplying/holding the second substrate 8 onto the holding surface 18a after electrically charging the holding surface 18a needs to be disposed in the chamber 1.

The supply holding means may also be used to hold the second substrate 8 in contact with the holding surface 18a instead of attracting the second substrate 8 onto the holding surface 18a in vacuum.

When the second substrate 8 is supplied from the outside of the chamber 1 in the second step, the chamber 1 is opened, and the substrate may be supplied onto the holding surface 18a of the upper holding table 18 by supply means such as a robot.

When the second substrate 8 is supplied to the holding surface 18a of the upper holding table 18, the anode voltage and the cathode voltage may continuously be applied to the first and second electrodes 19 and 20, or may be cut off. A voltage value in continuing to apply the direct-current voltage may be the same as or different from that in electrically charging the holding surface. In short, the polarity applied to each electrode has not to be changed.

When the second substrate 8 is held on the holding surface 18a, the changeover switches 37a, 38a of the first and second earth changing sections 37, 38 of the earth device 32 are changed to the state shown by the chain line from that shown by the solid line in FIG. 2 by the control device 39, and the first and second electrodes 19, 20 are earthed for a predetermined time, respectively. An earth step is carried out in this manner. Accordingly, as shown in FIG. 3, the electric charges of the anode accumulated in the first electrode 19 and those of the cathode accumulated in the second electrode 20 are discharged. Therefore, a state in which the electric charges are not accumulated in the electrodes 19, 20 is achieved.

When the earths of the respective electrodes 19, 20 are cut off, a third step shown in FIG. 5 is carried out. In the third step, the first changeover switches 33a, 34a of the first and second polarity changing sections 33, 34 of the switch device 31 are turned off, and the second changeover switches 33b, 34b are turned on. Accordingly, the cathode voltage of the second direct-current power supply 29 is applied to the first electrode 19, and the anode voltage of the first direct-current power supply 28 is applied to the second electrode 20. That is, in the third step, the polarities of the direct-current voltages applied to the first and second electrodes 19 and 20 are reversed.

When the polarities of the direct-current voltages applied to the respective electrodes 19, 20 are changed, and the voltage of the cathode is applied to the first electrode 19, the polarization occurs in the portion between the first electrode 19 and the holding surface 18a of the upper holding table 18 to form an anode at the lower surface of the first electrode 19 and a cathode at the holding surface 18a. The polarity of charge −E₂ generated on the holding surface 18a side by the polarization is negative as that of the charge −E₁ held beforehand on the holding surface 18a.

On the other hand, dielectric polarization occurs on the second substrate 8 when voltages are applied to the first and second electrodes 19 and 20. For the portion of the second substrate 8 corresponding to the first electrode 19, the polarization occurs to form an anode at the upper surface facing the holding surface 18a, and a cathode at the lower surface. Therefore, the portion of the second substrate 8 corresponding to the first electrode 19 is attracted/held by functions of both the cathode charges −E₁, −E₂.

Similarly, when the voltage of the anode is applied to the second electrode 20, the polarization occurs in the portion between the second electrode 20 and the holding surface 18a of the upper holding table 18 to form a cathode at the second electrode 20 and an anode at the holding surface 18a. The polarity of charge +E₂ generated at the holding surface 18a by the polarization is positive as that of the charge +E₁ held beforehand on the portion of the holding surface 18a corresponding to the second electrode 20.

On the other hand, the dielectric polarization occurs on the second substrate 8 when voltages are applied to the first and second electrodes 19 and 20. For the portion of the second substrate 8 corresponding to the second electrode 20, the polarization occurs to form a cathode at the upper surface facing the holding surface 18a, and an anode at the lower surface. Therefore, the portion of the second substrate 8 corresponding to the second electrode 20 is attracted/held by functions of both the anode charges +E₁, +E₂.

That is, as compared with a case where the second substrate 8 is simply held on the holding surface 18a and the direct-current voltage is applied, the second substrate 8 is attracted/held on the holding surface 18a with a strong holding force because the charges −E₁, +E₁ are held beforehand on the holding surface 18a in the first step. In other words, even when the direct-current voltages applied to the first and second electrodes 19 and 20 are not raised, a large electrostatic force can be produced on the holding surface 18a.

When the polarities of the direct-current voltages applied to the respective electrodes 19, 20 are changed in the third step, the pressure in the chamber 1 is preferably set to 80 kPa or less before the changing. When the pressure in the chamber 1 is set to 80 kPa or less, and the polarities applied to the respective electrodes 19, 20 are changed, the discharge can be prevented from occurring even via a gap between the holding surface 18a and the second substrate 8, if any, at the time of the changing. Accordingly, the charges −E₁, +E₁ supplied to the holding surface 18a in the first step and held by the second substrate 8 in the second step can be prevented from being alleviated by the discharge.

It is to be noted that when slight alleviation of the charge on the holding surface 18a is permitted, the polarities of the direct-current voltages applied to the respective electrodes 19, 20 may be changed in the atmosphere with a pressure of 80 kPa or more. After the second substrate 8 is held by the third step, the vacuum attraction by the second vacuum pump 22 may be stopped.

In the third step, after the electric charges accumulated in the electrodes 19, 20 in the first step, are discharged the voltage having the polarity different from that of the first step is applied. Therefore, the electric charges having polarities different from those charged in the first step can efficiently and quickly be accumulated in the respective electrodes 19, 20.

When the second substrate 8 is held on the holding surface 18a of the upper holding table 18 in this manner, the first substrate 7 held by the lower holding table 4 is driven in the horizontal direction by the first driving source 5 and positioned with the second substrate 8 in the chamber 1 brought in a predetermined reduced pressure atmosphere. Next, the upper holding table 18 is driven in the descending direction by the second driving source 23, and the second substrate 8 is bonded to the first substrate 7 via the sealing agent 9 at a predetermined load.

When the bonding ends, the first changeover switches 33b, 34b are turned off, and the changeover switches 37a, 38b of the first and second earth changing sections 37, 38 are changed into the state shown by the chain line of FIG. 2. Moreover, the gas is introduced into the chamber 1 via the gas supply tube 14, and the pressure in the chamber 1 is raised. Accordingly, the first and second substrates 7 and 8 bonded together are pressurized with a pressure larger than that at the time of the bonding, by the difference pressure between the pressures between one pair of substrates 7, 8 and in the chamber 1 and therefore an interval between the substrates 7, 8 is set to a predetermined value.

Thereafter, the suction hole 21 is connected to the pressurized gas supply source, and the gas is spouted from the suction hole 21. The upper holding table 18 is then raised. Accordingly, the second substrate 8 is detached from the holding surface 18a.

When the gas is spouted from the suction hole 21, the second substrate 8 is detached from the holding surface 18a. Therefore, even when the electric charges remain in the holding surface 18a after turning off the switches 33b, 34b, the second substrate 8 can easily and securely be detached from the holding surface 18a. Thereafter, when the chamber 1 is opened, and the bonded first and second substrates 7 and 8 are taken out, the bonding ends.

In accordance with the above-described embodiment, the following function/effect is obtained.

In the first step, the direct-current voltages having the predetermined polarities are applied to the first and second electrodes 19 and 20 to charge the holding surface 18a of the upper holding table 18 with the electric charges −E₁, +E₁. In the second step, the second substrate 8 is vacuum-attracted and held on the holding surface 18a. Next, in the third step, the polarity of the direct-current voltage applied to the first and second electrodes 19 and 20 is changed to the polarity reverse to that of the first step.

Therefore, as compared with a case where the second substrate 8 is simply held on the holding surface 18a and the direct-current voltages having the predetermined polarities are applied to the first and second electrodes 19 and 20, the second substrate 8 can securely be attracted/held on the holding surface 18a with a strong holding force because the holding surface 18a of the upper holding table 18 is charged beforehand with the charges −E₁, +E₁ in the first step.

Therefore, when the present invention is applied to the bonding apparatus as described above, the second substrate 8 held by the holding surface 18a can be prevented from dropping, the bonding operation can therefore be prevented from being discontinued by the dropping of the second substrate 8 from the holding surface 18a, and an operation ratio of the bonding apparatus can be raised.

Moreover, since the second substrate 8 held on the holding surface 18a can be prevented from dropping, the first and second substrates 7, 8 can be prevented from being damaged or becoming dirty by the dropping of the second substrate 8 from the holding surface 18a, thus the yield in the bonding operation can be enhanced.

Furthermore, the second substrate 8 can be prevented from shifting on the holding surface 18a at the time of the bonding operation of two substrates 7, 8 by the first driving source 5 or by the second driving source 23. Accordingly, a positional deviation between two substrates 7, 8 can be prevented from being caused by the shifting of the second substrate 8 on the holding surface 18a. A quality of a liquid crystal display panel manufactured by bonding two substrates 7, 8 together can therefore be enhanced.

Before removing the bonded first and second substrates 7 and 8 from the chamber 1, that is, when the bonding ends and the second substrate 8 is detached from the upper holding table 18, the direct-current voltages having the predetermined polarities are applied to the first and second electrodes 19 and 20 of the upper holding table 18 as described above, and the first step of charging the holding surface 18a with the electric charges may be started. Accordingly, a tact time required for the bonding can be reduced.

It is to be noted that the reduction of the tact time is not limited to a case where the first step is started at the time of the detaching of one pair of bonded substrates from the upper holding table 18. The first step may be started between when the bonded substrates are detached from the table 18 and when the next first substrate 7 is supplied to the lower holding table 4. That is, when the first step is carried out in parallel with another operation such as a delivery operation of the bonded substrates, the tact time can be reduced as compared with a case where the first is carried out after supplying the substrate 7 to the lower holding table 4.

The present invention is not limited to the above-described embodiment, and may also be applied, for example, to a constitution in which the electrode is also disposed on the lower holding table and the substrate is held by the electrode with the electrostatic force in the same manner as in the upper holding table.

One pair of electrodes are disposed on the upper holding table, but a plurality of pairs of electrodes may also be disposed, or only one electrode may also be disposed. When the electrode is also disposed on the lower holding table, at least one electrode may be disposed in the same manner as in the upper holding table.

In the first and third steps, the polarities of the direct-current voltages applied to the first and second electrodes may also be changed automatically by the control device, or may manually be changed without using any control device.

After the second step, the earth step of grounding the first and second electrodes for the predetermined time is carried out, but the third step may also be carried out after the second step without performing the earth step.

In the second step, the second substrate is held on the holding surface of the upper holding table by the vacuum attraction. However, when it is possible to hold the second substrate with the suction force by the electric charge generated on the holding surface, the second substrate may also be held on the holding surface of the upper holding table only with the suction force.

The chamber 1 is divided into lower and upper chambers, but a box-shaped chamber including an outlet/inlet port of the substrate in side walls may also be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electrostatic attracting method in which a direct-current voltage is applied to an electrode disposed at a table formed of a dielectric material to attract/hold a substrate onto a holding surface of the table with an electrostatic force produced thereby, the method characterized by comprising:
a first step of applying a voltage having a predetermined polarity to the electrode to charge the holding surface with an electric charge having a polarity different from that applied to the electrode;
a second step of holding the substrate on the holding surface; and
a third step of applying a voltage having a polarity different from that applied in the first step to the electrode in a state in which the substrate is held on the holding surface to produce an electric charge having the same polarity as that charged on the holding surface in the first step at the holding surface of the table, and attracting/holding the substrate with the electric charge together with the electric charge charged on the holding surface in the first step.

2. The electrostatic attracting method according to claim 1, characterized in that the first step is carried out under a pressure atmosphere, and charged particles exist in the pressure atmosphere.

3. The electrostatic attracting method according to claim 2, characterized in that at least one of steam and oxygen exists in the pressure atmosphere.

4. The electrostatic attracting method according to claim 1, characterized in that the third step is carried out in a pressure atmosphere of 80 kPa or less.

5. The electrostatic attracting method according to claim 1, characterized by further comprising:
an earth step of grounding the electrode to discharge the electric charge accumulated in the electrode before applying the voltage to the electrode.

6. An electrostatic attracting apparatus which attracts/holds a substrate, characterized by comprising:
a table formed by a dielectric material and including a holding surface which holds the substrate by an electrostatic force;
an electrode disposed at the table;
a direct-current power supply which applies a direct-current voltage onto the electrode; and
switch means for switching a polarity of a direct-current voltage applied to the electrode by the direct-current power supply,
wherein after applying the direct-current voltage having a predetermined polarity to the electrode, the substrate is held on the holding surface, the switch means is operated to apply a direct-current voltage having a different polarity to the electrode.

7. The electrostatic attracting apparatus according to claim 6, characterized in that the table is disposed in a chamber, and a pressure of an inner space of the chamber can be reduced by pressure reducing means.

8. The electrostatic attracting apparatus according to claim 6, characterized in that the chamber is connected to charged particle supply means for supplying charged particles to the inner space.

9. A bonding apparatus in which a fluid is disposed between two substrates to bond these substrates to each other by a sealing agent, the apparatus characterized by comprising:
a chamber in which a pressure of an inner space can be reduced;
a pair of tables which are disposed opposite to each other in the chamber and which include holding surfaces to hold the substrates on the surfaces disposed opposite to each other and at least one of which is formed of a dielectric material;
an electrode disposed at the table formed of the dielectric material;
a direct-current power supply which applies a direct-current voltage to the electrode and produces an electrostatic force to hold the substrate on the holding surface of the table;
switch means for switching a polarity of the direct-current voltage applied to the electrode by the direct-current power supply; and
driving means for driving the pair of tables with respect to each other in vertical and horizontal directions and positioning the substrates held on the holding surfaces of the pair of tables in the horizontal direction to bond the substrates to each other,
wherein after applying the direct-current voltage having a predetermined polarity to the electrode, the substrate is held on the holding surface, the switch means is operated to apply a direct-current voltage having a different polarity to the electrode.

10. The bonding apparatus according to claim 9, characterized by further comprising: an earth device which discharges electric charges accumulated in the electrode before applying the direct-current voltage having the different polarity to the electrode.

11. The bonding apparatus according to claim 9, characterized in that an open hole communicating with a gas introducing source is formed in the holding surface.
